(19) United States
(12) Patent Application Publication
(10) Pub. No.: US 2009/0261741 A1
(43) Pub. Date: Oct. 22, 2009

(54) Cover figure-displaying device for an electronic device

(75) Inventors: Chao-Fu Huang, Kellung City (TW); Chien-Chiang Huang, Taoyuan County (TW); Huang-Fu Lin, Taoyuan County (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/222,432

(22) Filed: Aug. 8, 2008

(30) Foreign Application Priority Data
Apr. 18, 2008 (TW) 97114286

(51) Int. Cl. G09G 3/30

(52) U.S. Cl. 315/169.3

(57) ABSTRACT

A cover figure-displaying device for an electronic device includes a cover, a controller, and a light-emitting matrix. The cover has at least one figure. The controller has GPIO pins. The light-emitting matrix includes at least one light-emitting device connected with the controller. The controller controls the GPIO pins to select the lighting position, color, timing, and duration on the light-emitting matrix.

### RELATED APPLICATIONS

This application claims priority to Taiwan Application Serial Number 97114286, filed Apr. 18, 2008, which is herein incorporated by reference.

### BACKGROUND

1. Field of Invention

The present invention relates to figure-displaying device. More particularly, the present invention relates to cover figure-displaying device for an electronic device.

2. Description of Related Art

Consumer electronics are most often used in entertainment, communications and office productivity. In today's marketplace, as choices of electronic devices grow, the ornamental design of electronic devices becomes one of the design considerations the producer might emphasize. The ornamental design of electronic devices might also be a deciding factor when consumers make purchases. However, the products currently available simply offer consumers cover replacements with different colors. When it takes into account that consumers have different needs to pursue novel and changeful design, still there is room to develop the ornamental design for electronic devices.

### SUMMARY

According to one embodiment of the present invention, a cover figure-displaying device for an electronic device includes a cover, a controller, and a light-emitting matrix. The cover has at least one figure. The controller has GPIO pins. The light-emitting matrix includes at least one light-emitting device connected with the controller. The controller controls the GPIO pins to select the lighting position, color, timing, and duration on the light-emitting matrix.

According to another embodiment of the present invention, a cover figure-displaying device for an electronic device includes a cover, a controller, a FPC, a light-emitting matrix, an iron board, a display panel, and a display bezel. The cover has at least one figure arranged in the form of a matrix. The controller has GPIO pins. The controller includes a memory having a figure display program stored therein. The FPC includes a circuit-controlling module connected with the GPIO pins of the controller, and the circuit-controlling module includes at least one control circuit. The light-emitting matrix includes at least one light-emitting device connected with the control circuit of the circuit-controlling module, and the disposition of the light-emitting device corresponds to the location of the figure on the cover. The iron board affixed to the FPC supports the FPC. The display panel is affixed to the cover. When the figure display program is executed, the controller controls the GPIO pins to select the lighting position, color, timing, and duration on the light-emitting matrix via the control circuit.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing the appearance of an electronic device with a cover figure-displaying device implemented thereon;

FIG. 2 is a top view showing the appearance of an electronic device with a cover figure-displaying device implemented thereon;

FIG. 3 is a cross sectional view of a display module for an electronic device;

FIG. 4 is a block diagram showing the control module of a cover figure-displaying device for an electronic device;

FIG. 5 is a diagram showing the inner structure of an electronic device cover;

FIG. 6 is a diagram showing the disposition of the light-emitting devices and the FPC;

FIG. 7 is a diagram showing the disposition of the iron board and the FPC;

FIG. 8 is a diagram showing the disposition of the display panel; and

FIG. 9 is a diagram showing the disposition of the display bezel.

### DESCRIPTION OF THE PREFERRED EMBODIMENTS

Reference will now be made in detail to the embodiment of this invention, examples of which are illustrated in the accompanying drawings. Wherever possible, the same reference numbers are used in the drawings and the description to refer to the same or like parts.

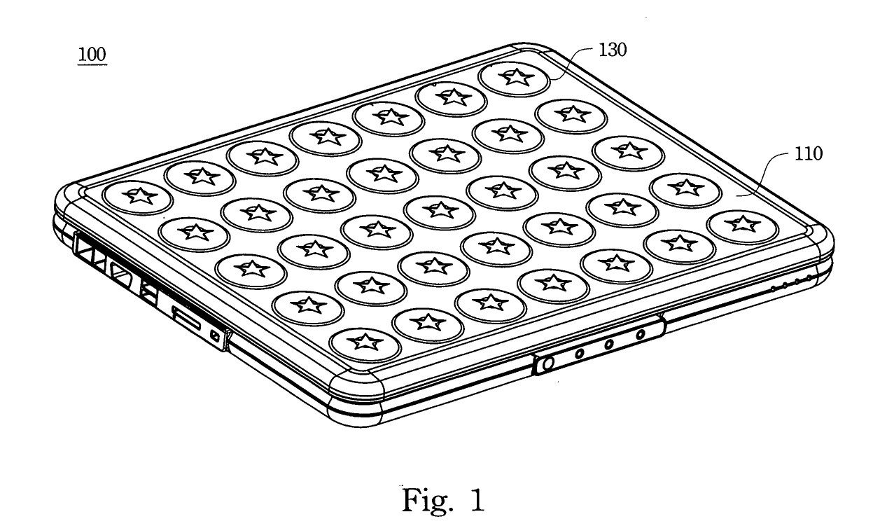

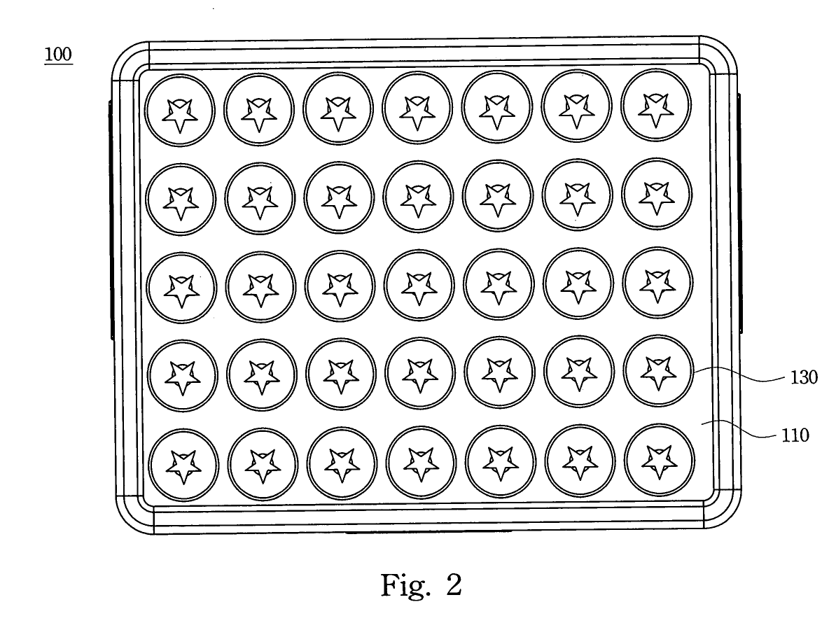

Refer to FIG. 1 and FIG. 2. FIG. 1 is a diagram showing the appearance of an electronic device with a cover figure-displaying device implemented thereon. FIG. 2 is a top view showing the appearance of an electronic device with a cover figure-displaying device implemented thereon. The cover 110 of the electronic device 100 has at least one figure 130 to be displayed thereon. In this embodiment, the figure 130 including a star and a circle surrounding the star is arranged in the form of a matrix on the cover 110 of the electronic device 100. When the light-emitting device placed under the figure 130 emits light, the shape of the figure 130 clearly shows out. The electronic device 100 can be a notebook computer or a mobile phone, for example. The shape and arrangement of the figure 130 are chosen or decided based on different requirements from case to case. The arrangement of the figure 130 is not limited to the form of a matrix. However, the matrix is preferred because various presentation or pattern, and color combinations can be easily combined and presented via a matrix.

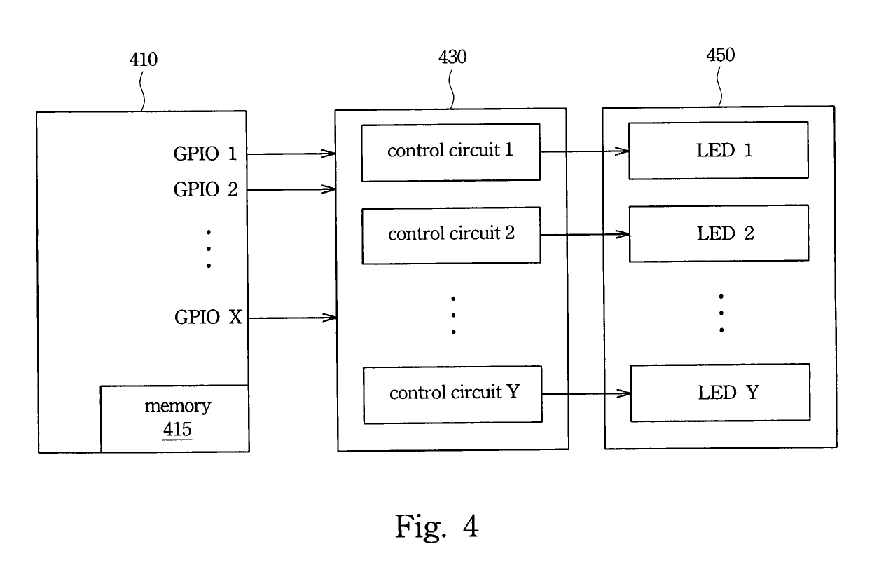

Refer to FIG. 4. FIG. 4 is a block diagram showing the control module of a cover figure-displaying device for an electronic device. The control module includes a controller 410, a circuit-controlling module 430, and a light-emitting matrix 450. The controller 410 has GPIO pins such as GPIO 1, GPIO 2 . . . GPIO X shown in the figure. The controller 410 includes a memory 415, and a figure display program can be stored therein. The controller 410 can access or read data from the memory 415. For instance, the memory 415 can be a ROM built in the controller 410, or an external memory or storage device. The circuit-controlling module 430 is connected with the controller 410 via the GPIO pins. The circuit-controlling module 430 includes at least one control circuit such as control circuit 1, control circuit 2 . . . control circuit Y shown in the figure. The light-emitting matrix 450 includes at least one light-emitting device. The light-emitting device can be a light emitting diode such as LED 1, LED 2 . . . LED Y shown in the figure. Each light-emitting device is connected with one of the control circuit in the circuit-controlling module 430. For example, LED 1 is connected with control circuit 1, LED 2 is connected with control circuit 2, and LED Y is connected with control circuit Y.

When the figure display program is executed, the controller 410 controls the GPIO pins to select emitting or lighting position, color, timing, and duration on the light-emitting matrix 450 via the control circuit 430. Depending on the practical requirement or specification, the color of the light-emitting devices can be a single color or multiple colors (such as red, blue, green, etc) to composite various colors. In one embodiment, the light-emitting device can emit at least one color of red, blue, and green. Each of the control circuit can use three control signals to decide the lighting position and color. The timing to active or close the emitting (for example, enter turn-on, turn-off, or stand-by, or at a specific time), the emitting color (single color or composited colors), the lighting position, or the emitting duration can be stored in the figure display program in advance. Alternatively, a user can input a command via an input device (such as mouse or keyboard) to select the lighting position, color, timing, and duration on the light-emitting matrix.

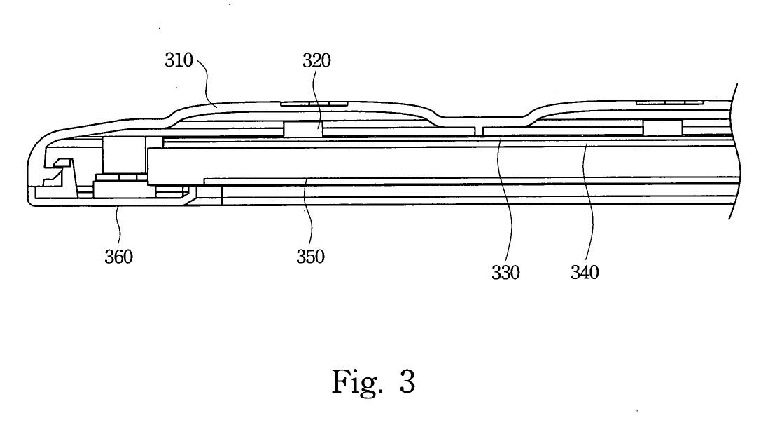

Refer to FIG. 3 and FIG. 4. FIG. 3 is a cross sectional view of a display module for an electronic device. In FIG. 3, the first layer 310 is the cover, and the second layer 320 includes a FPC 620 (Flexible Printed Circuit) and the light-emitting matrix 450. The circuit-controlling module 430 can be implemented on the FPC 620. The third layer 330 is an iron board. The fifth layer 350 is a display panel. The forth layer 340 is the space between the iron board and the display panel. The sixth layer 360 is a display bezel.

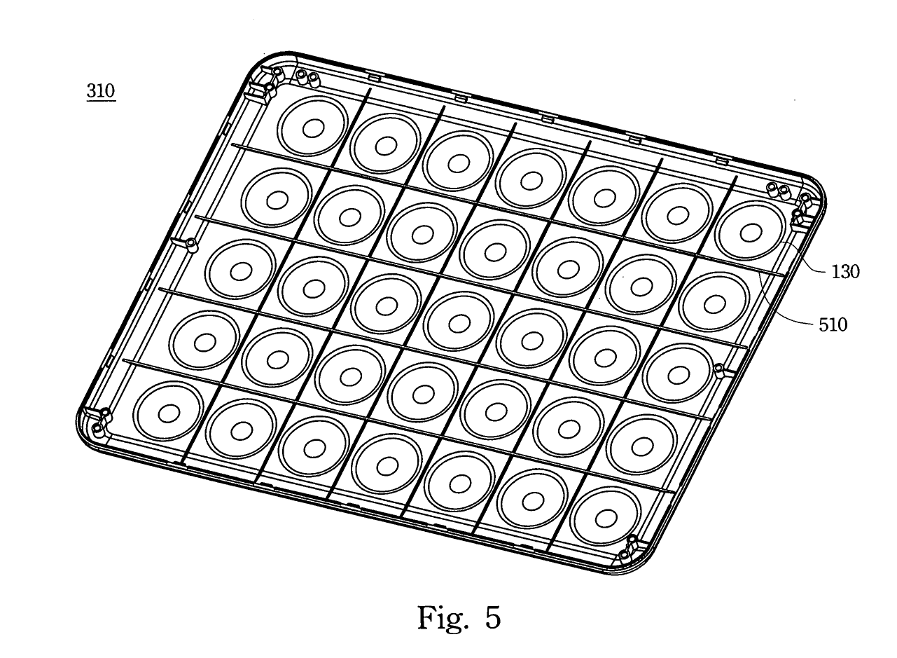

Refer to FIG. 5. FIG. 5 is a diagram showing the inner structure of an electronic device cover. The inner structure of the electronic device cover 310 includes at least one figure 130 and rib 510. The ribs 510 corresponding to the figure 130 are functioning as sidewalls to shield the light emitted by the light-emitting devices, thus preventing the light interference among the light-emitting devices. The cover 310 is made of translucent material, and the figures 130 are thinner than other parts of the cover 310 to let the light go through. The cover 310 could be manufactured by using the technique of in-mold decoration (IMD) or spray-painting on a transparent cover.

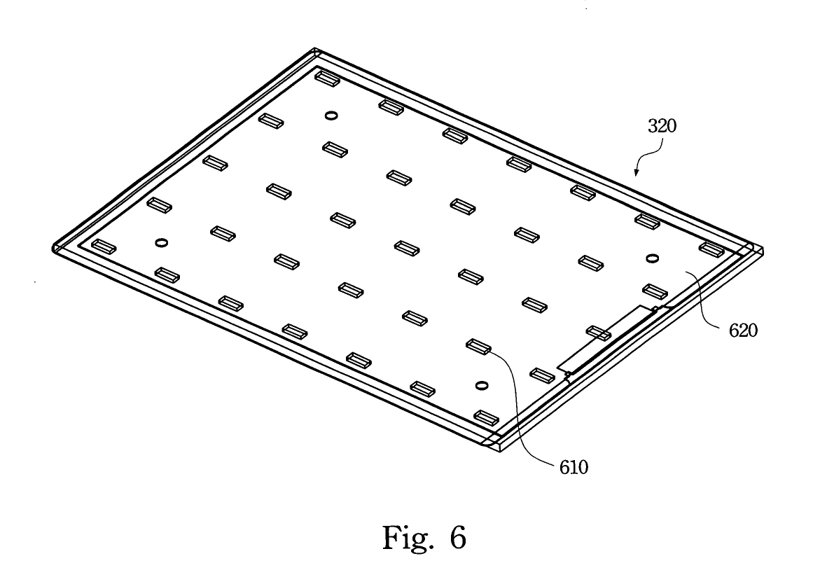

Refer to FIG. 6. FIG. 6 is a diagram showing the disposition of the light-emitting devices and the FPC 620FPC (the second layer 320 shown in FIG. 3). The light-emitting devices 610 are placed on the FPC 620 corresponding to the figure 130 on the cover 310. Thus, various presentations or patterns might be presented by controlling the switch for each light-emitting device 610 in the light-emitting matrix 450. Besides, the various presentations or pattern of the figure can be generated via users' directly control for each of the light-emitting device, or via programs stored on the memory 415, etc. Presentations or patterns of the figure can be a company's name or logo, or an user's name, etc.

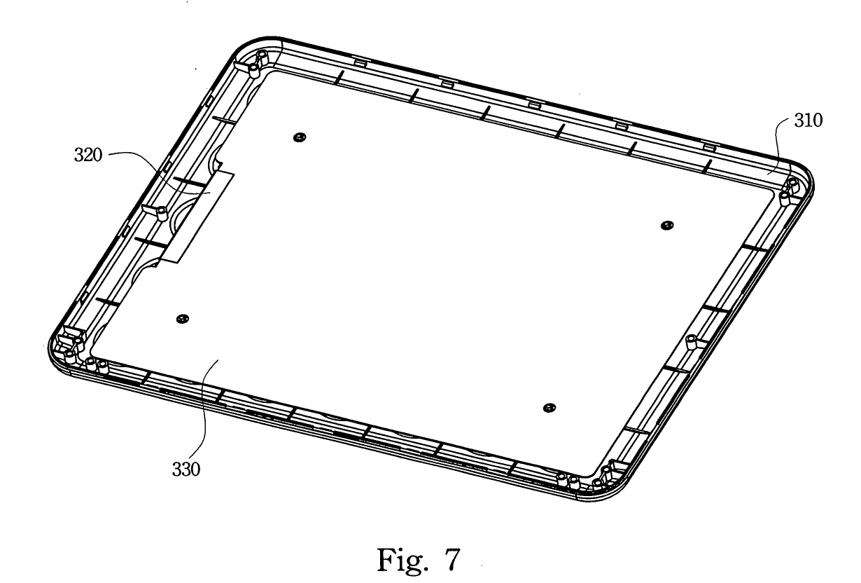

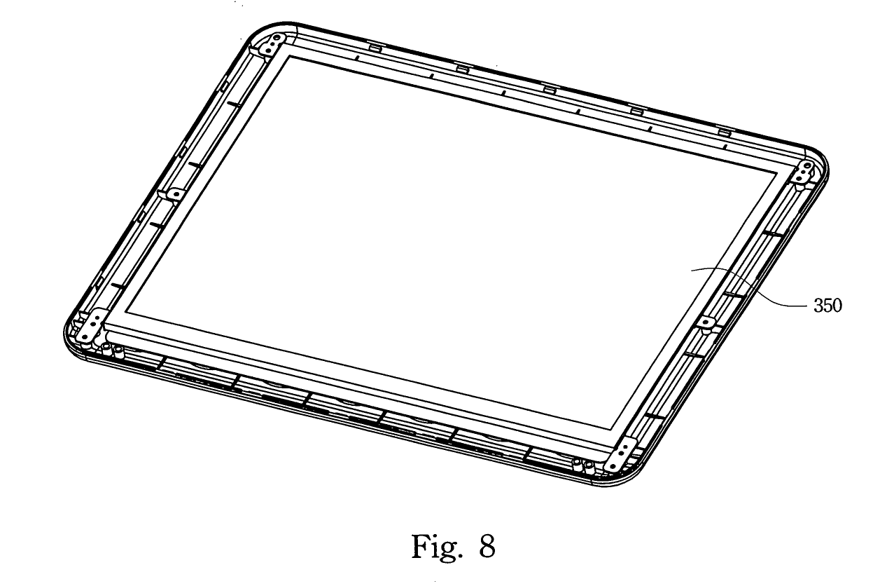

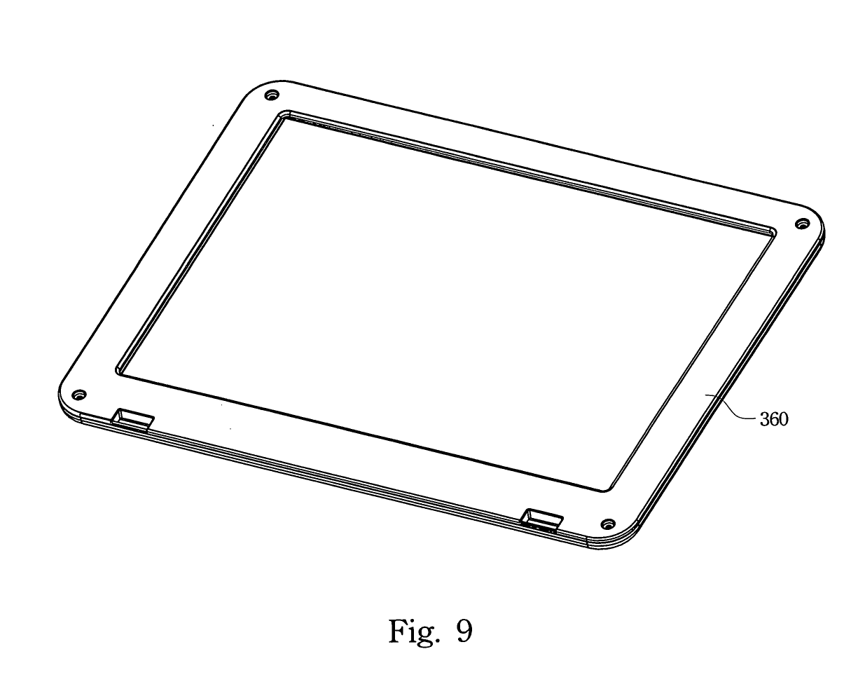

FIG. 7 is a diagram showing the disposition of the iron board and the FPC. The iron board is affixed to the FPC and the light-emitting matrix. That is, as shown in FIG. 3, the third layer 330 is affixed to the second layer 320. The iron board is used to support the FPC and the light-emitting matrix. Furthermore, screws can be used to affix the first layer 310, the second layer 320, and the third layer 330 together. FIG. 8 is a diagram showing the disposition of the display panel 350. FIG. 9 is a diagram showing the disposition of the display bezel 360.

In conclusion, the embodiment provides the electronic device various the appearances. This can be done by incorporating the hardware and firmware on the electronic device. The embodiment increases the usefulness, novelty, and market value of the electronic device. Additionally, users can decide the presentations of figure on the cover by themselves, which makes ornamental design activities more interesting.

It will be apparent to those skilled in the art that various modifications and variations can be made to the structure of the embodiment without departing from the scope or spirit of the invention. In view of the foregoing, it is intended that the embodiment cover modifications and variations of this invention provided they fall within the scope of the following claims and their equivalents.

What is claimed is:

1. A cover figure-displaying device for an electronic device comprising:
a cover having at least one figure;
a controller having a plurality of GPIO pins; and
a light-emitting matrix comprising at least one light-emitting device connected with the controller;
wherein the controller controls the GPIO pins to select lighting position, color, timing, and duration for the light-emitting matrix.

2. The device of claim 1, further comprising a circuit-controlling module connected with the controller via the GPIO pins, the circuit-controlling module comprising at least one control circuit connected with the light emitting device.

3. The device of claim 2, wherein the controller further comprises a memory for storing a figure display program.

4. The device of claim 3, wherein the controller controls the lighting position, color, timing, and duration for the light-emitting matrix by executing the figure display program.

5. The device of claim 2, wherein the cover further comprising at least one rib corresponding to the figure.

6. The device of claim 2, wherein the figure is arranged in a form of a matrix on the cover.

7. The device of claim 2, wherein the disposition of the light-emitting device corresponds to the location of the figure on the cover.

8. The device of claim 2, further comprising a flexible printed circuit for implementing the circuit-controlling module.

9. The device of claim 8, further comprising an iron board for supporting the flexible printed circuit.

10. The device of claim 2, further comprising an input device for inputting a command to select the lighting position, color, timing, and duration for the light-emitting matrix.

11. The device of claim 2, wherein the cover is made of translucent material.

12. The device of claim 2, wherein the cover is manufactured by in-mold decoration (IMD) or spray-painting on a transparent cover.

13. The device of claim 2, wherein the light-emitting device is a light emitting diode.

14. A cover figure-displaying device for an electronic device comprising:
a cover having at least one figure arranged in a form of a matrix;
a controller having a plurality of GPIO pins and a memory for storing a figure display program;
a flexible printed circuit comprising a circuit-controlling module connected with the GPIO pins of the controller, the circuit-controlling module comprising at least one control circuit;
a light-emitting matrix comprising at least one light-emitting device connected with the control circuit of the circuit-controlling module, wherein the disposition of the light-emitting device corresponds to the location of the figure on the cover;
an iron board affixed to the flexible printed circuit for supporting the flexible printed circuit;
a display panel affixed to the cover; and
a display bezel;
wherein when the figure display program is executed, the controller controls the GPIO pins to select lighting position, color, timing, and duration on the light-emitting matrix via the control circuit.

15. The device of claim 14, wherein the cover further comprises at least one rib corresponding to the figure.

16. The device of claim 15, further comprising an input device for inputting a command to select the lighting position, color, timing, and duration on the light-emitting matrix.

17. The device of claim 16, wherein the cover is made of translucent material.

18. The device of claim 16, wherein the cover is manufactured by in-mold decoration (IMD) or spray-painting on a transparent cover.

19. The device of claim 18, wherein the light-emitting device is a light emitting diode.

20. The device of claim 19, wherein the electronic device is a notebook or mobile phone.
